(19) United States
(12) Patent Application Publication
(10) Pub. No.: US 2010/0240299 A1
(43) Pub. Date: Sep. 23, 2010

(54) Content data acquisition system

(75) Inventor: Shuji Karino, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/659,635

(22) Filed: Mar. 16, 2010

(30) Foreign Application Priority Data
Mar. 18, 2009 (JP) 2009-66502

(51) Int. Cl. H04H 40/00; G06F 15/16

(52) U.S. Cl. 455/3.06; 709/202

(57) ABSTRACT

A content data acquisition system is disclosed. The content data acquisition system includes a broadcasting center for providing content data divided into partial data by distributing the partial data in one-way communication; and multiple data acquisition apparatuses each mounted to a vehicle and each capable of individually acquiring the partial data from the broadcasting center. One data acquisition apparatus mounted to one vehicle determines whether an amount of the already acquired partial data is enough to reconstruct the content data. When the amount of the already acquired partial data is determined to be not enough to reconstruct the content data, the one data acquisition apparatus acquires a remaining part of the partial data from another data acquisition apparatus mounted to another vehicle in inter-vehicle communication.

### CROSS REFERENCE TO RELATED APPLICATION

The present application is based on Japanese Patent Application No. 2009-66502 filed on Mar. 18, 2009, disclosure of which is incorporated herein by reference.

### BACKGROUND OF THE INVENTION

1. Field of the Invention

The present invention relates to a content data acquisition system for acquiring distributed content data.

2. Description of Related Art

An in-vehicle information system such as a telematics and the like has become sophisticated year by year. Accordingly, there is a growing need for distributing a large amount of data from a content distribution server to an in-vehicle information system. When a cellular phone network is used for data distribution, it is necessary to distribute content data to in-vehicle information systems one by one in two-way communication, resulting in the following difficulties. The data distribution is inefficient. The content distribution sever may be subjected to too much load, and the cellular phone network may have heavy traffic.

JP-2004-274415A discloses a technique for addressing the above difficulties. The technique is as follows. The downloading jobs of respective partial data of target data are allocated to multiple in-vehicle information systems. Each in-vehicle information system downloads the allocated partial data, and at least one of the in-vehicle information systems reconstructs the target data by acquiring the respective partial data from the other in-vehicle information systems by using inter-vehicle communication.

There is another way for data distribution other than that uses the cellular phone network. The another way uses a data channel of satellite radio broadcasting via which a variety of contents, e.g., traffic information and entertainment information, can be distributed in one-way communication. When a vehicle manufacture has a data channel of satellite radio broadcasting as a leased channel, the vehicle manufacture can distribute the content that are specific to their vehicles. For example, the vehicle manufacture can distribute an update program, POI (point of interest) information or the like for an in-vehicle navigation apparatus. When the data distribution is performed using a method of transmitting redundant data segments, an in-vehicle information system can receive the redundant data segments and reconstruct the content data.

The inventor of the present application has found that a conventional technique involves the following difficulty. According to the technique disclosed in JP-2004-274415A, the downloading jobs of partial data are allocated to multiple in-vehicle information systems, and then, instructions for performing the downloading job are issued to the in-vehicle information systems. Because of the above configuration, each time one in-vehicle information system moves into an inter-vehicle communication un-performable area after having received the downloading instruction, the downloading job allocated to the one in-vehicle information system should be re-allocated to another in-vehicle formation system or the reconstruction of content data becomes impossible. The technique disclosed in JP-2004-274415A therefore involves a difficulty of taking a large amount of time and effort to acquire the partial data that are enough to reconstruct the content data.

According a conventional method for distributing data via the satellite radio broadcasting, when an amount of data to be distributed is large, it takes too long to acquire the data that is enough to reconstruct the content data. Thus, depending on a time a user drives a vehicle equipped with an in-vehicle information system, it becomes difficult to acquire the data enough to reconstruct the content data. The reconstruction of content data becomes difficult.

### SUMMARY OF THE INVENTION

In view of the above and other difficulties, it is an objective of the present invention to provide a content data acquisition system that is capable of reducing a load applied to a distributor of content data and capable of acquiring data enough to reconstruct content data in an easy manner and in a short amount of time.

According to a first aspect of the present invention, there is provided a content data acquisition system including: a broadcasting center configured to provide content data divided into partial data by distributing the partial data in one-way communication; and multiple data acquisition apparatuses each capable of individually acquiring the partial data from the broadcasting center. The multiple data acquisition apparatuses includes: subject data acquisition apparatus mounted to a subject vehicle and multiple other data acquisition apparatuses respectively mounted to multiple other vehicles. The subject data acquisition apparatus includes: an inter-vehicle communication device configured to perform inter-vehicle communication to perform data transmission between the subject data acquisition apparatus and the other data acquisition apparatuses; a data amount determination section configured to determine whether an amount of the partial data already acquired by the subject data acquisition apparatus is enough to reconstruct the content data; a complement target search section configured to identify a target data acquisition apparatus from among the other data acquisition apparatuses with which the subject data acquisition apparatus is communicatable in the inter-vehicle communication, when the data amount determination section determines that the amount of the partial data already acquired by the subject data acquisition apparatus is not enough to reconstruct the content data, wherein the target data acquisition apparatus is one of the other data acquisition apparatuses that has already acquired a part of the partial data, wherein the part of the partial data has not been acquired by the subject data acquisition apparatus and is required for the subject data acquisition apparatus to reconstruct the content data; and a complement section configured to acquire the part of the partial data from the target data acquisition apparatus via the inter-vehicle communication device in the inter-vehicle communication when the complement target search section successfully identifies the target data acquisition apparatus.

According to a second aspect of the present invention, there is provided a content data acquisition system including: a broadcasting center configured to provide content data divided into partial data by distributing the partial data in one-way communication; and multiple data acquisition apparatuses each capable of individually acquiring the partial data from the broadcasting center. The multiple data acquisition apparatuses includes a subject data acquisition apparatus mounted to a subject portable device and multiple other data acquisition apparatuses respectively mounted to multiple other portable devices. The subject data acquisition apparatus includes: an inter-portable-device communication device configured to perform inter-portable-device communication, to perform data transmission between the subject data acquisition apparatus and the other data acquisition apparatuses; a data amount determination section configured to determine whether an amount of the partial data already acquired by the subject data acquisition apparatus is enough to reconstruct the content data; a complement target search section configured to identify a target data acquisition apparatus from among the other data acquisition apparatuses with which the subject data acquisition apparatus is communicatable in the inter-portable-device communication, when the data amount determination section determines that the amount of the partial data already acquired by the subject data acquisition apparatus is not enough to reconstruct the content data, wherein the target data acquisition apparatus is one of the other data acquisition apparatuses that has already acquired a part of the partial data, wherein the part of the partial data has not been acquired by the subject data acquisition apparatus and is required for the subject data acquisition apparatus to reconstruct the content data; and a complement section configured to acquire the part of the partial data from the target data acquisition apparatus via the inter-portable-device communication device in the portable-device-to-portable-device communication when the complement target search section successfully identifies the target data acquisition apparatus.

According to the above systems, it is possible to reduce a load applied to a distributor of content data and it is possible to acquire data enough to reconstruct content data in an easy manner and in a short amount of time.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a content data acquisition system according to a first embodiment;

FIG. 2 is a block diagram illustrating a data acquisition apparatus according to the first embodiment;

FIG. 3 is a flowchart illustrating a flow of processes relevant to content data acquisition and content data reconstruction in the data acquisition apparatus according to the first embodiment;

FIG. 4 is a block diagram illustrating a content data acquisition system according to a second embodiment;

FIG. 5 is a block diagram illustrating a data acquisition apparatus according to the second embodiment; and

FIG. 6 is a flowchart illustrating a flow of processes relevant to content data acquisition and content data reconstruction in the data acquisition apparatus according to the second embodiment.

### DETAILED DESCRIPTION OF THE EXEMPLARY EMBODIMENTS

Exemplary embodiments are described below with reference to the accompanying drawings.

### First Embodiment

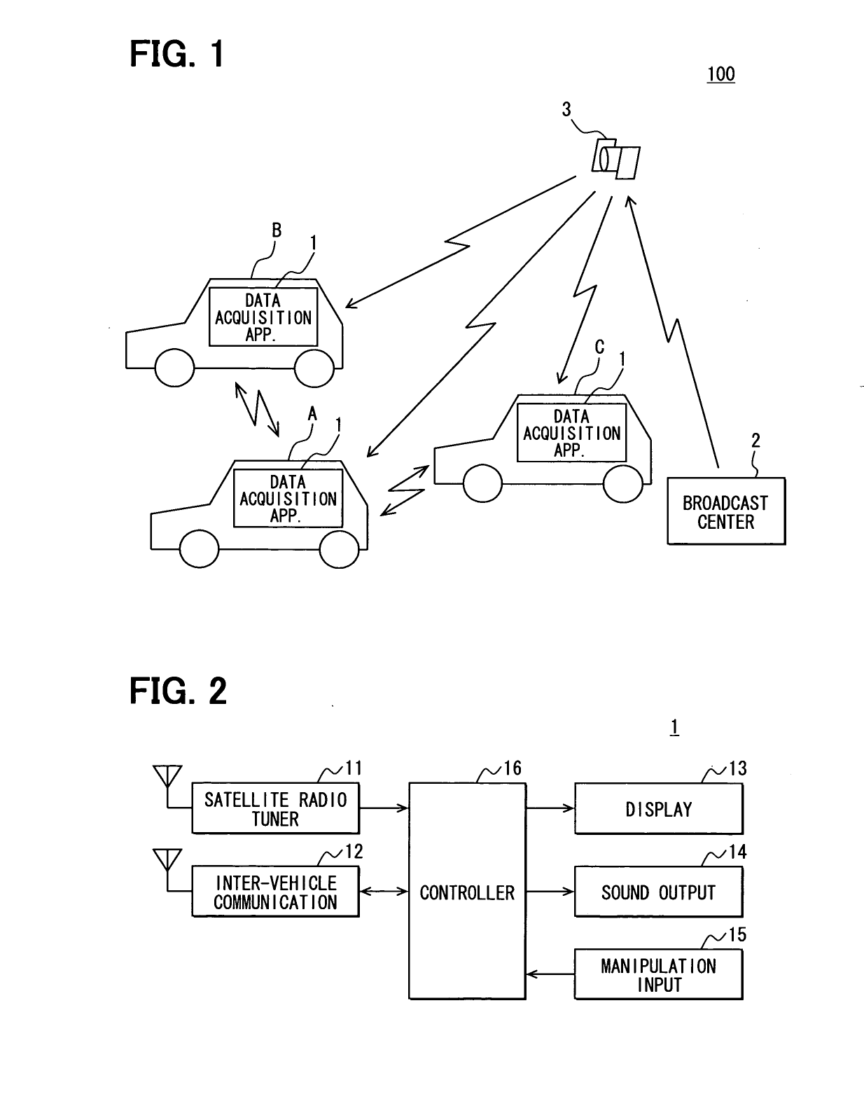

FIG. 1 is a block diagram illustrating a content data acquisition system 100 according to a first embodiment. The content data acquisition system 100 includes a broadcasting center 2, an artificial satellite 3, and multiple data acquisition apparatus 1 mounted to multiple vehicles. For illustrative purpose, the multiple vehicles may be also referred to as a vehicle “A”, a second vehicle “B”, and a vehicle “C”.

The broadcasting center 2 is for satellite radio broadcasting, and transmits content data of satellite radio broadcasting to the data acquisition apparatus 1 via the artificial satellite 3 in the form of radio wave in one-way communication. The broadcasting center 2 divides the content data into multiple partial data while providing redundancy (i.e., multiplexes) to the multiple partial data. The broadcasting center 2 provides the content data through successively transmitting and distributing the multiple partial data. For providing redundancy, a known redundant conversion technique is used. Since the partial data are made redundant using the redundant conversion technique, the data acquisition apparatus 1 can reconstruct the original content data by receiving only a certain amount or number of the partial data. Moreover, IDs are assigned to each unit of the partial data. The IDs are, for example, a content ID for identification of the original content data and a data ID for identification of the use of the partial data of the original content data.

In the above, the one-way communication is a communication method in which data transmission occurs only from a transmission side and reception side. Such simplex communication is generally used in broadcasting. The content data to be distributed from the broadcasting center 2 includes a radio program, music, traffic information, an update program and a POI information for an in-vehicle navigation apparatus, and the like.

The artificial satellite 3 receives the content data (more specifically the partial data) from the broadcasting center 2 in the form of radio wave, and transmits the content data (more specifically the partial data) in the form of circularly-polarized radio wave.

In the present embodiment, it is assumed that the partial data are distributed from the broadcasting center 2 in the one-way communication without charge (i.e., free).

In the above configuration, although the broadcasting center 2 is for satellite radio broadcasting, this configuration can be modified. For example, the broadcasting center 2 may be for digital television broadcasting. Moreover, a transmission way for the broadcasting center 2 is not limited to the above-described satellite waves, and may be a terrestrial broadcast. When terrestrial broadcasting is used as a transmission way for the broadcasting center 2, a relay station for relaying the terrestrial broadcasting may be used in place of the artificial satellite 3.

The data acquisition apparatus 1 is mounted to a vehicle such as automobile and the like. It is assumed in the present embodiment that the data acquisition apparatuses 1 are respectively mounted to the vehicles A, B and C, each of which is an automobile. The data acquisition apparatus 1 is configured to receive partial data, which are distributed from the broadcasting center 2 via the artificial satellite 3 in the one-way communication. The data acquisition apparatus 1 is further configured to perform inter-vehicle communication with other data acquisition apparatuses 1 of other vehicles, so that data is transmittable between the multiple data acquisition apparatuses 1.

FIG. 1 illustrates the content data acquisition system 100 including three data acquisition apparatuses 1 respectively mounted to there vehicles (vehicles A, B, C). However, a configuration of the content data acquisition system 100 is not limited to FIG. 1. For example, two or more data acquisition apparatuses 1 each equipped in a vehicle the may suffice in the content data acquisition system 100. The content data acquisition system 100 may include two or more than three data acquisition apparatuses 1 each equipped with a vehicle. For illustrative purpose, it is assumed in the present embodiment that the content data acquisition system 100 includes three data acquisition apparatus 1 mounted to vehicles A, B, C.

Explanation will be given below on a schematic configuration of the data acquisition apparatus 1 with reference to FIG. 2. FIG. 2 is a block diagram illustrating the data acquisition apparatus 1. As shown in FIG. 2, the data acquisition apparatus 1 includes a satellite radio tuner 11, an inter-vehicle communication device 12, a display device 13, a sound output device 14, an operation input device 15, and a controller 16 connected with the foregoing components.

The satellite radio tuner 11 is configured to receive partial data, which are distributed from the artificial satellite 3 using circularly-polarized radio wave. The inter-vehicle communication device 12 is configured to perform inter-vehicle communication so that data is transmittable between the inter-vehicle communication device 12 of the data acquisition apparatus 1 mounted to a subject vehicle and those mounted to other vehicles. Hereinafter, a data acquisition apparatus 1 mounted to a subject vehicle is also referred to as a subject data acquisition apparatus 1. Data acquisition apparatuses 1 mounted to other vehicles, which are vehicles other than the subject vehicle, are also referred to as other data acquisition apparatuses 1. The inter-vehicle communication device 12 may be configured to perform data transmission and data reception using Bluetooth, wireless LAN or the like.

The display device 13 can display text, image and the like. The display device 13 may include a liquid crystal display, organic electroluminescence (EL) display, plasma display or the like. Alternatively, the data acquisition apparatuses 1 may use a display device of an in-vehicle navigation apparatus as the display device 13.

The sound output device 14 include a speaker to output sound, speech and the like under control of the controller 16. Alternatively, the data acquisition apparatuses 1 may use a speaker of an in-vehicle navigation apparatus or a speaker of a car audio system as the speaker.

The operation input device 15 may include a touch sensitive switch provided on the display device 13, or a mechanical switch. In response to operation of the touch sensitive switch or the mechanical switch, the operation input device 15 issue various instructions to the controller 16 to execute predetermined functions, e.g., selection of the content to be acquired. The operation input device 15 may include a remote control device. The remote control device inputs various instruction signals to the controller 16 in response to switch operation, and thereby causing the controller 16 to execute various functions. The operation input device 15 may include a speech recognition unit. The speech recognition unit recognizes speech inputted via a microphone and issues a control command corresponding to the recognized speech to the controller 16, thereby causing the controller 16 to execute various functions. The data acquisition apparatuses 1 may use a group of operation switches, a remote control device or a speech recognition unit of an in-vehicle navigation apparatus as the operation input device 15. The operation input device 15 receives an operation input from a user. The operation input device 15 may be also referred to as a manipulation input device 15.

The controller 16 may be configured as a microcomputer. The controller 16 includes therein a CPU, a ROM, a ROM, an I/O, and a bus line (any of which is not shown) connecting the foregoing components. The controller 16 performs processes relevant to content data acquisition and content data reconstruction, based on a variety of information inputted from the satellite radio tuner 11, the inter-vehicle communication device 12 and the operation input device 15. For example, the controller 16 performs a data amount determination process, a complement target search process, an inter-vehicle communication complement process, and a content data reconstruction process.

The controller 16 performs the data amount determination process to determine whether an amount of the already-acquired partial data is enough to reconstruct the content data. The controller 16 can thereby act as a data amount determination section or means. For example, based on partial data received with the satellite radio tuner 11, the controller 16 determines whether an amount of the already-acquired partial data is enough to reconstruct the content data. Moreover, when the controller 16 acquires partial data, for instance, from the other data acquisition apparatus 1 of another vehicle by using the below-described inter-vehicle communication, the controller 16 determines whether an amount of the already-acquired partial data is enough to reconstruct the content data based on the previously-acquired partial data and the newly-acquired partial data. Furthermore, for example, even prior to reception of partial data of the content data, when a content ID of the content data that a user desires to acquire is evident from already-acquired information, the controller 16 goes through processes by assuming that an amount of the already-acquired partial data is not enough to reconstruct the content data. In the above, the already-acquired information is, for example, the below described table information, broadcast program information which was distributed in advance from the broadcasting center 2, or the like.

The controller 16 has an electrically rewritable memory (not shown) such as EEPROM (electrically erasable and programmable read only memory) and the like. In the electrically rewritable memory, the controller 16 stores a table associated with partial data received with the satellite radio tuner 11. For example, for every content data that the satellite radio tuner 11 has received partial data of, the table relates a content ID of the content data to a data ID of the already-acquired partial data of the content data. The controller 16 also stores the already-acquired partial data in the electrically rewritable memory such as EEPROM and the like.

When the controller 16 determines that an amount of the already-acquired partial data is not enough to reconstruct the target content data, the controller 16 performs the complement target search process. In the complement target search process, the controller 16a searches through the other data acquisition apparatuses 1 with which the subject data acquisition apparatus 1 communicatable in the inter-vehicle communication, and identifies a target data acquisition apparatus 1 from among the other data acquisition apparatuses 1. In the above, the target data acquisition apparatus 1 is the one that has already acquired a part (e.g., a remaining part) of the partial data, which part is required for the subject data acquisition apparatus 1 to reconstruct the content data and which part has not been acquired by the subject data acquisition apparatus 1. The controller 16 can thereby act as a complement target search section or means. In the complement target search process, the controller 16 searches for the target data acquisition apparatus 1 based on the content IDs and the data IDs contained in the tables that are stored in the electrically rewritable memories of the controllers 16 of the other data acquisition apparatuses 1. More specifically, as a target data acquisition apparatus 1, the controller 16 of the subject data acquisition apparatus 1 identifies a data acquisition apparatus 1 in which the table has (i) a content ID of the target content data (referred to also as a target content ID), and (ii) a data ID that is related to the target content ID but not stored in the table in controller 16 of the subject data acquisition apparatus 1.

When the controller 16 successfully finds out and identifies the target data acquisition apparatus 1, the controller 16 performs an inter-vehicle communication complement process to acquire the remaining part of the partial data from the target data acquisition apparatus 1 via the inter-vehicle communication. The controller 16 can thereby act as a first complement section or means.

When the controller 16 acquires an amount of the partial data enough to reconstruct the target content data, the controller 16 performs a content data reconstruction process to reconstruct the target content data by using the already-acquired partial data. Depending on types of the reconstructed content data, the controller 16 may perform various operations, e.g., outputting sound from the sound output device 14, displaying an image on the display device, and updating a program of the in-vehicle navigation apparatus, and the like.

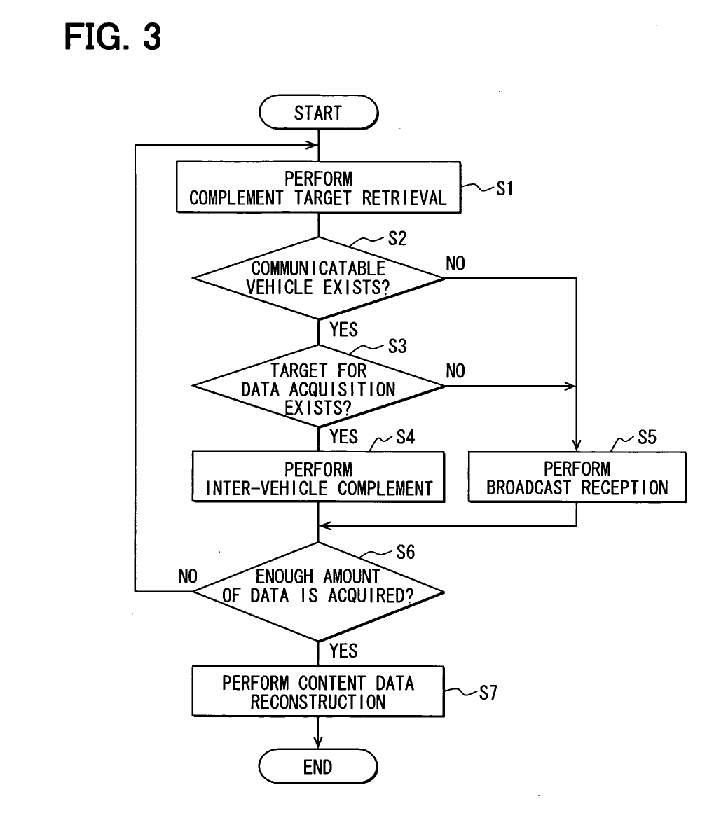

Referring to FIG. 3, explanation will be given on a flow of processes relevant to content data acquisition and content data reconstruction in the data acquisition apparatus 1. FIG. 3 is a flowchart illustrating processes relevant to the content data acquisition and the reconstruction. The data acquisition apparatus 1 starts performing the flow of processes when partial data of target content data is needed. For example, the data acquisition apparatus 1 starts performing the flow of processes when the data acquisition apparatus 1 is about to start acquiring the content data. Alternatively, the data acquisition apparatus 1 may start performing the flow of processes when the data acquisition apparatus 1 fails to acquire partial data enough to reconstruct the target content data because, for example, the acquisition of partial data is interrupted.

At S1 to S3, the controller 16 performs the complement target search process (i.e., complement target retrieval). At S1, the controller 16 searches for the other data acquisition apparatuses 1 with which the subject data acquisition apparatus 1 is communicatable via the inter-vehicle communication device 12 in the inter-vehicle communication. For example, when it is assumed that the vehicle A is a subject vehicle, and the vehicles B, C, which are different from the vehicle A, are other vehicles, the controller 16 searches for the data acquisition apparatuses 1 of the other vehicles B, C by checking whether the inter-vehicle communication device 12 of the subject vehicle A can establish inter-vehicle communication with those of the other vehicles B, C.

At S2, the controller 16 determines based on the search of the other vehicles whether a communicatable vehicle exists. More specifically, the controller 16 determines based on the search whether there is the other data acquisition apparatus 1 with which the subject data acquisition apparatus 1 can establish the inter-vehicle communication. When the controller 16 determines that a communicatable vehicle exists, corresponding to “YES” at S2, the process proceeds to S3. When the search of the other data acquisition apparatus 1 reveals that there is no other data acquisition apparatus 1 with which the subject data acquisition apparatus 1 can establish the inter-vehicle communication, the controller 16 determines that no communicatable vehicle exists, corresponding to “NO” at S2, and the process proceeds to S5.

At S3, the controller 16 determines whether a target data acquisition apparatus 1, which is a target for data acquisition, exists. More specifically, the controller 16 identifies the target data acquisition apparatus 1 from among the other data acquisition apparatuses 1 with which the subject data acquisition apparatus 1 can establish the inter-vehicle communication. In the above, the target data acquisition apparatus 1 is the one that has already acquired a part (e.g., a remaining part) of the partial data, which part is required for the subject data acquisition apparatus 1 to reconstruct the contend data and which part has not been acquired by the subject data acquisition apparatus 1. When the controller 16 successfully finds out and identifies the target data acquisition apparatus 1, the controller 16 determines that the other data acquisition apparatus 1 has partial data that is complementary with another partial data already acquired by the subject data acquisition apparatus 1, in other words, the controller determines that the a target for data acquisition exists. In this case, the determination at S3 results in “YES” and the process proceeds to S4. When the controller 16 cannot find out and identify the target data acquisition apparatus 1, the controller 16 determines that the other data acquisition apparatus 1 does not have any partial data that is complementary with the partial data already acquired by the subject data acquisition apparatus 1, in other words, the controller determines that the a target for data acquisition does not exist. In this case, the determination at S3 results in “NO” and the process proceeds to S5. It should be noted that, at S3, the controller 16 may find out and identify one or more target data acquisition apparatuses 1.

At S4, the controller 16 performs the inter-vehicle communication complement process while targeting to one of the target data acquisition apparatuses 1. In the above, the targeted one is the target data acquisition apparatus 1 that has a largest amount of the remaining part of the partial data among the multiple target data acquisition apparatuses 1. After S4, the process proceeds to S6.

At S5, the controller 16 performs a broadcasting reception process. After S5, the process proceeds to S6. In the broadcasting reception process, for a predetermined period of time, the controller 16 waits for the broadcasting center 2 to distribute a remaining part of the partial data, which is required to reconstruct the target content data. When the remaining part of the partial data is received with the satellite radio tuner 11, the controller 16 acquires the received remaining part of the partial data, and the process proceeds to S6. In the broadcasting reception process, when the remaining part of the partial data cannot be received with the satellite radio tuner 11, the process proceeds to S6 after the elapse of the predetermined period of time. In the above, the predetermined period of time is an arbitrarily-settable period.

At S6, the controller 16 performs the data amount determination process to determine whether an amount of the partial data already acquired by the subject data acquisition apparatus 1 is enough to reconstruct the target content data. When the controller 16 determines that an amount of the already-acquired partial data is enough to reconstruct the target content data, corresponding to “YES” at S6, the process proceeds to S7. When the controller 16 determines that an amount of the already-acquired partial data is not enough to reconstruct the target content data, corresponding to “NO” at S6, the process returns to S1, and the flow of processes is performed again.

At S7, the controller 16 performs the content data reconstruction process to reconstruct the content data, and then, the flow of processes is ended.

According to the present embodiment, the content data is divided into the partial data and the partial data are distributed from the broadcasting center 2 in the one-way communication. Thus, even when the content data to be distributed is a large amount of data, it is possible to reduce a load applied to a distributer of the content data, compared to a case where the content data is distributed in the two-way communication.

According to the present embodiment, moreover, even if the inter-vehicle communication becomes impossible or breaks between the subject vehicle and a certain vehicle targeted as a sender of a certain part of the partial data and even if it becomes impossible for the subject data acquisition apparatus 1 to acquire the certain part of the partial data from the certain vehicle, the subject data acquisition apparatus 1 searches for another data acquisition apparatuses 1 mounted to another vehicle to identify, from among other data acquisition apparatuses 1, a target data acquisition apparatus 1 that also has the certain part of the partial data. Therefore, by acquiring the certain part of the partial data from the target data acquisition apparatus 1, the subject data acquisition apparatus 1 can acquire data needed to reconstruct the target content data. Accordingly, even if the inter-vehicle communication becomes impossible or breaks between the subject vehicle and a certain vehicle targeted as a sender of a certain part of the partial data and even if the subject data acquisition apparatus 1 becomes impossible to acquire the certain Part of the partial data from the certain vehicle, there is no need for a different data acquisition apparatus 1 to newly acquire the certain part of the partial data from the broadcasting center 2. It is possible to acquire data just enough to reconstruct the content data in a easy manner and in a short period of time. For example, because there is a high possibility that multiple vehicles made by the same vehicle manufacture gets together at a gathering place of vehicles (e.g., a business district, a parking lot of a mall), the multiple data acquisition apparatuses 1 of the vehicles at such place can share the partial data by using an inter-vehicle-communication-based P2P (peer to peer) network. The complement of partial data for reconstruction of content data can be realized. It becomes possible to more easily shorten a time taken to reconstruct content data.

As a result, according to the present embodiment, it becomes possible to reduce a load of a distributor (e.g., a broadcasting center 2) of content data, and in addition, it becomes possible to acquire data just enough for reconstruction of content data in an easy manner and in a short period of time.

Moreover, according to the present embodiment, since the subject data acquisition apparatus 1 can acquire a remaining part of partial data, which part is needed to reconstruct content data, from a target data acquisition apparatus 1 by using in inter-vehicle communication without charge, it becomes unnecessary for a different data acquisition apparatus 1 of a different vehicle to acquire partial data by using a paid communication system such as cellular-phone-network-based two-way-communication and the like. It should be noted that the inter-vehicle communication can generally be performed without charge. In a system that requires a data acquisition apparatus 1 of another vehicle to perform a paid operation, it would be difficult to have cooperation from a driver of the another vehicle. Thus, it is highly likely that such a system lacks versatility. According to the present embodiment, in contrast, since it is unnecessary for a data acquisition apparatus 1 of another vehicle to perform a paid operation, it is easy to have cooperation from a driver of the another vehicle, and it is possible to enhance versatility.

Moreover, according to the present embodiment, before acquiring partial data from a broadcasting center 2, the subject data acquisition apparatus 1 can acquire a remaining part of partial data, which part is needed to reconstruct content data, from a target data acquisition apparatus 1 by using inter-vehicle communication. Accordingly, it is possible to reduce an amount of data to be acquired from the broadcasting center 2, and it is possible to further shorten an amount of time taken to acquire partial data from the broadcasting center 2. It is possible to therefore reduce a wait time before acquiring partial data from the broadcasting center 2, improving usability.

### Second Embodiment

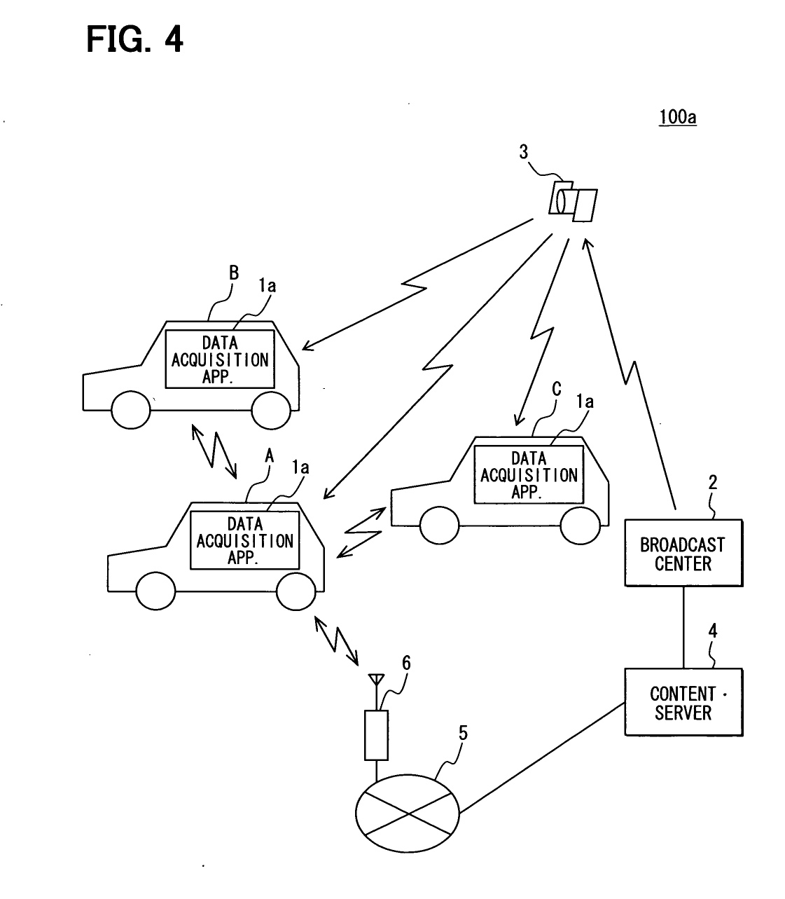

A second embodiment is illustrated below with reference to FIGS. 4 to 6. FIG. 4 is a block diagram illustrating a schematic configuration of a content data acquisition system 100a according to the second embodiment. Between the first and second embodiments, like numerical references are used by referring to like parts or processes.

As shown in FIG. 4, the content data acquisition system 100a includes multiple data acquisition apparatuses 1a equipped with multiple vehicles (e.g., a vehicle A, a vehicle B, a vehicle C), a broadcasting center 2, an artificial satellite 3, a content server 4, a network 5, and a base station 6.

The content server 4 has content data that is to be distributed from the broadcasting center 2, and content data that has been already distributed from the broadcasting center 2. The content sever 4 distributes partial data, into which content data is divided, to data acquisition apparatuses 1a via the network 5 and the base station 6 in the two-way communication. The content server 4 can act as an information center. It assumed in the present embodiment that partial data of content data transmitted from the content server 4 in the two-way communication are distributed with charge.

The network 5 is a communication network enabling the data acquisition apparatus 1a and the content server 4 to perform communications therebetween. For example, it is assumed in the present embodiment that the network 5 is a cellular phone network. The base station 6 is an apparatus capable of interacting directly with the data acquisition apparatus 1a. One or more of the base stations 6 are connected with one or more of terminals of the network 5.

In the above, the network 5 is illustrated as a cellular phone network, but not limited to the cellular phone network. For example, the network 5 may be Internet.

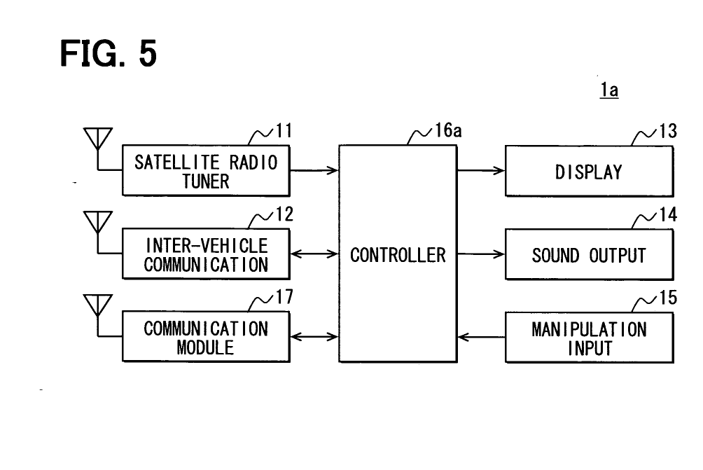

The data acquisition apparatus 1a is mounted to a vehicle such as an automobile and the like. It is assumed in the present embodiment that the multiple data acquisition apparatuses 1a are respectively mounted to vehicles A to C, each of which is an automobile. A schematic configuration of the data acquisition apparatus 1a is illustrated below with reference FIG. 5. As shown in FIG. 5, the data acquisition apparatus 1a includes a satellite radio tuner 11, an inter-vehicle communication device 12, a display device 13, a sound output device 14, a operation input device 15, a communication module 17, and a controller 16a connected with the foregoing components.

The data acquisition apparatus 1a of the present embodiment is similar to the data acquisition apparatus 1a of the first embodiment, except that: the data acquisition apparatus 1a can acquire partial data by performing two-way communication with the content server 4 via the network 5 and the base station 6; the data acquisition apparatus 1a includes the communication module 17 for the two-way communication; and the data acquisition apparatus 1a uses the controller 16a in place of the controller 16 to perform processes related to the two-way communication.

The communication module 17 performs the two-way communication with the content server 4 via the network 5 and the base station 6 to acquire partial data of target content data from the content sever 4. As the communication module 17, the data acquisition apparatus 1a may use an in-vehicle communication module for telematics communication, such as DCM (data communication module) and the like. Alternatively, as the communication module 17, the data acquisition apparatus 1a may use a cellular phone that is connected with the data acquisition apparatus 1a using Bluetooth (registered trademark).

Based on various information inputted from the satellite radio tuner 11, the inter-vehicle communication device 12, the operation input device 15 and the communication module 17, the controller 16a performs processes relevant to content data acquisition and content data reconstruction, e.g., a data amount determination process, a complement target search process, an inter-vehicle communication complement process, a data request complement process, a content data reconstruction process, and the like.

The controller 16a of the subject data acquisition apparatus 1a performs the data request complement process when the controller 16a determines that an amount of the partial data already acquired by the subject data acquisition apparatus 1a is not enough to reconstruct the target content data, and when the operation input device 15 receives an operation input (also referred to as a content quick acquisition request) that instructs to acquire a remaining part of the partial data from the content server 4. In the above, a remaining part of the partial data is a part that the subject data acquisition apparatus 1a has not acquired yet and that the subject data acquisition apparatus 1a needs to reconstruct the target content data. In the data request complement process, the controller 16a performs the two-way communication with the content server 4 via the network 5 and the base station 6, and requests the content server 4 to transmit the remaining part of the partial data, thereby acquiring the remaining part of the partial data from the content server 4. The controller 16a can act as a second complement section or means.

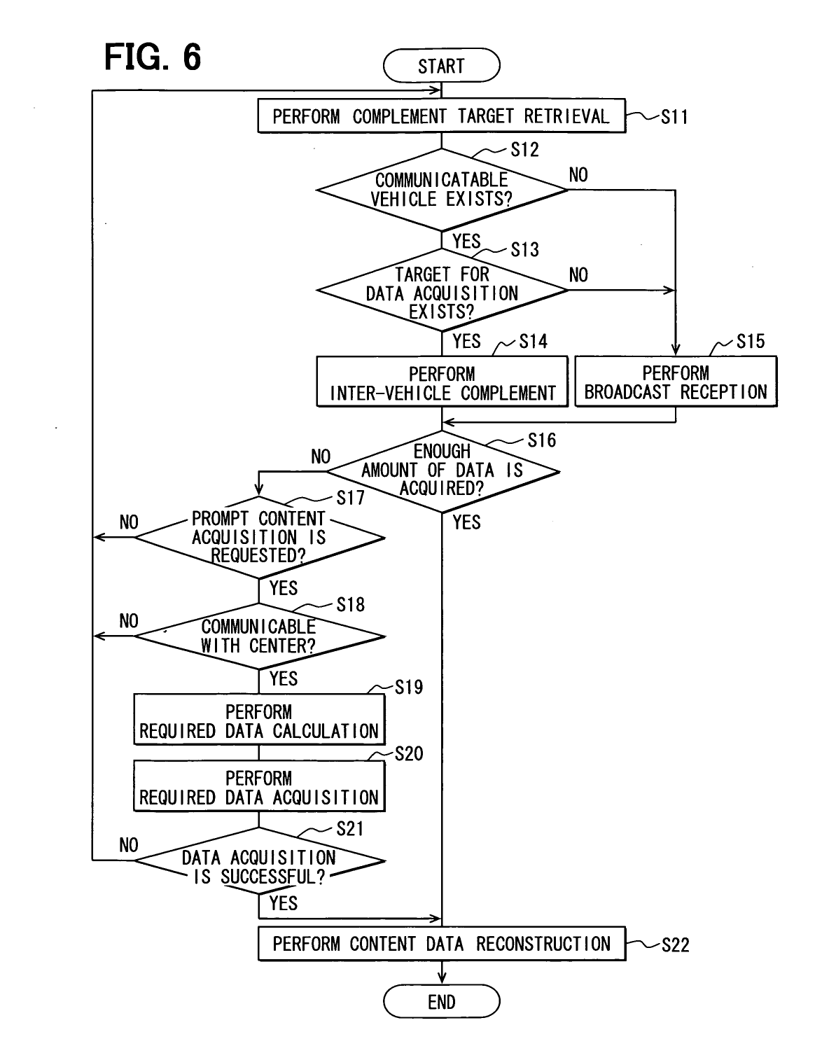

Referring to FIG. 6, there will be described below a flow of processes relevant to content data acquisition and content data reconstruction in the data acquisition apparatus 1a. The data acquisition apparatus 1a starts performing the flow of processes when partial data of target content data is needed. For example, the data acquisition apparatus 1a starts performing the flow of processes when being about to start acquiring the content data. Alternatively, the data acquisition apparatus 1a may start performing the flow of processes when failing to acquire partial data enough to reconstruct the target content data because of, for example, the interruption of partial data acquisition.

S11 to S15 in FIG. 6 can be the same as S1 to S5 in FIG. 3. For S11 to S15, refer to the first embodiment.

At S16, the controller 16a performs the data amount determination process to determine whether an amount of the already-acquired partial data is enough to reconstruct the target content data. When the controller 16a determines that an amount of the already-acquired partial data is enough to reconstruct the target content data, in other words, when the subject data acquisition apparatus 1a has already acquired the enough amount of partial data, the determination at S16 results in “YES” and the process proceeds to S22. When the controller 16a determines that an amount of the already-acquired partial data is not enough to reconstruct the target content data, corresponding to “NO” at S16, the process proceeds to S17.

At S17, the controller 16a causes the display device 13 or the sound output device 14 to provide display or sound to a user to inquire whether a remaining part of the partial data, which is required to reconstruct the target content data, is to be acquired from the content data in the two-way communication. For example, through the display of the display device 13 or the sound of the sound output device 14, the controller 16a may provide a user with information “it takes long to complete content acquisition, would you like to quickly acquire the content by paying fees?, thereby inquiring whether content quick acquisition is to be performed. After providing a user with an inquiry regarding whether content quick acquisition is to be performed, the controller 16a determines whether the operation input device 15 receives an operation input indicative of the content quick acquisition request. When the controller 16a determines that the operation input device 15 receives an operation input indicative of the content quick acquisition request, corresponding to “YES” at S17, the process proceeds to S18. When the controller 16a determines that the operation input device 15 does not receive an operation input indicative of the content quick acquisition request, corresponding to “NO” at S17, the process returns to S11 so that the flow of processes is performed again.

At S18, the controller 16a determines whether the communication module 17 is communicatable with the content server 4 in the two way communication. To determine whether the communication module 17 is communicatable with the content server 4 in the two way communication, the controller 16a may determine whether the communication module 17 is in a communicatable range of the base station 6. In the present disclosure, the two-way communication with the content server 4 may be referred to also as a center communication. When the controller 16a determines that the center communication is possible, corresponding to “YES” at S18, the process proceeds to S19. When the controller 16a determines that the center communication is not possible, corresponding to “NO” at S18, the process returns to S11 so that the flow of processes is performed again.

At S19, the controller 16a performs a required data calculation process, and the process proceeds to S20. In the required data calculation process, the controller 16a calculates an amount of a remaining part of the partial data. The amount of the remaining part is required for the subject data acquisition apparatus 1a to reconstruct the target content data.

At S20, the controller 16a performs a required data acquisition process, and the process proceeds to S21. In the required data acquisition process, the controller 16a request the content server 4 to transmit the amount of the partial data calculated at the required data calculation process, and acquires the requested partial data.

At S21, the controller 16a determines whether the amount of the partial data calculated at the required data calculation process has successfully been acquired in the required data acquisition process, in other words, the controller 16a determines whether the partial data acquisition is successful. When the controller 16a determines that the partial data acquisition is successful, corresponding to “YES” at S21, the process proceeds to S22. When the controller 16a determines that the partial data acquisition is not successful, corresponding to “NO” at S21, the process returns to S11 so that the flow of processes is performed again.

At S22, the controller 16a performs the content data reconstruction process, and the flow of processes is ended.

In the complement target search process of the present embodiment, a target in the search may not be limited to the data acquisition apparatus 1a. The target in the search may further include the data acquisition apparatus 1. In the inter-vehicle communication complement process of the present embodiment, a target for the partial data acquisition may not be limited to the data acquisition apparatus 1a. The target may further include the data acquisition apparatus 1.

According to the present embodiment, the content data acquisition system 100a enables reduction of a load applied to distributer of content data and enables more easy and quick acquisition of the data that is just enough to reconstruct content data, in a manner similar to that in the content data acquisition system 100.

Moreover, according to the above present embodiment, when an amount of the already-acquired partial data is not enough to reconstruct the target content data even after the acquisition of partial data from the broadcasting center 2 in the one way communication and even after the acquisition of partial data from other vehicles in the inter-vehicle communication cannot provide, the controller 16a sends to a user an inquiry about whether quick acquisition of the target content data in the two way communication with charge is to preformed. When a user would like the content quick acquisition, the partial data required to reconstruct the target content data can be acquired in the two way communication. It becomes possible to meet time requirements.

The above embodiments can be modified in various ways, examples of which are described below.

The above embodiments illustrate an exemplary configuration in which a data acquisition apparatus is applied to an apparatus mounted to a vehicle. Alternatively, a data acquisition apparatus may be applied to a portable communication terminal such as a cellular phone, a PDA (personal digital assistant) and like, which can be carried by a user. A data acquisition apparatus applied to a portable communication terminal may includes the same components as the data acquisition apparatus 1 or 1a mounted to the vehicle includes, and the data acquisition apparatus applied to the portable communication terminal may use a communication device for data transmission between multiple portable communication terminals (i.e., inter-portable-device communication) in place of the inter-vehicle communication device 12, and may complement the partial data by using wireless communication between the multiple portable communication terminals. The portable communication terminal can act as a portable device, and the communication device can act as an inter-portable-device communication device.

In the above embodiments, the partial data of content data are redundant data. However, the partial data of content data may not be limited to this configuration. For example, the partial data may not be redundant. In this case, the acquisition of a predetermined amount (or number) of partial data or less may not make it possible to reconstruct content data, and the reconstruction of content data may require all of the partial data produced in the dividing of the content data. Then, the data acquisition apparatus may be configured to further specify a type of the remaining part, which is needed to reconstruct the content data, of the partial data based on a content ID and a data ID, and acquire the required type of the remaining part.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of procedures, processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be installed in a computer via a communications network.

What is claimed is:

1. A content data acquisition system comprising:
a broadcasting center configured to provide content data divided into partial data by distributing the partial data in one-way communication; and
a plurality of data acquisition apparatuses each capable of individually acquiring the partial data from the broadcasting center, the data acquisition apparatuses including
a subject data acquisition apparatus mounted to a subject vehicle and
a plurality of other data acquisition apparatuses respectively mounted to a plurality of other vehicles,
the subject data acquisition apparatus including:
an inter-vehicle communication device configured to perform inter-vehicle communication to perform data transmission between the subject data acquisition apparatus and the other data acquisition apparatuses;
a data amount determination section configured to determine whether an amount of the partial data already acquired by the subject data acquisition apparatus is enough to reconstruct the content data;
a complement target search section configured to identify a target data acquisition apparatus from among the other data acquisition apparatuses with which the subject data acquisition apparatus is communicatable in the inter-vehicle communication, when the data amount determination section determines that the amount of the partial data already acquired by the subject data acquisition apparatus is not enough to reconstruct the content data,
the target data acquisition apparatus being one of the other data acquisition apparatuses that has already acquired a part of the partial data, the part (i) having not been acquired by the subject data acquisition apparatus and (ii) being required for the subject data acquisition apparatus to reconstruct the content data; and
a first complement section configured to acquire the part of the partial data from the target data acquisition apparatus via the inter-vehicle communication device in the inter-vehicle communication when the complement target search section successfully identifies the target data acquisition apparatus.

2. The content data acquisition system according to claim 1, wherein:
when the data amount determination section determines that the amount of the partial data already acquired by the subject data acquisition apparatus is not enough to reconstruct the content data even after the first complement section has acquired the part of the partial data, the complement target search section searches for another target data acquisition apparatus that has already acquired another part of the partial data, the another part (i) having not been acquired by the subject data acquisition apparatus and (ii) being required for the subject data acquisition apparatus to reconstruct the content data; and
when the complement target search section successfully searches for the another target data acquisition apparatus, the first complement section acquires, the another part of the partial data from the another target data acquisition apparatus via the inter-vehicle communication device in the inter-vehicle communication.

3. The content data acquisition system according to claim 1, further comprising:
an information center configured to provide the content data divided into the partial data by distributing the partial data in two-way communication,
wherein the subject data acquisition apparatus further includes:
an operation input device configured to receive an operation input from a user; and
a second complement section configured to request the information center to transmit a remaining part of the partial data and acquire the remaining part of the partial data from the information center in the two-way communication when the data amount determination section determines that the amount of the partial data already acquired by the subject data acquisition apparatus is not enough to reconstruct the content data and when the operation input device receives the operation input that instructs to acquire that the remaining part of the partial data from the information center, the remaining part (i) having not been acquired by the subject data acquisition apparatus and (ii) being required for the subject data acquisition apparatus to reconstruct the content data.

4. The content data acquisition system according to claim 3, wherein:
the information center distributes the partial data in the two-way communication with charge.

5. A content data acquisition system comprising:
a broadcasting center configured to provide content data divided into partial data by distributing the partial data in one-way communication; and
a plurality of data acquisition apparatuses each capable of individually acquiring the partial data from the broadcasting center, the data acquisition apparatuses including
a subject data acquisition apparatus mounted to a subject portable device and
a plurality of other data acquisition apparatuses respectively mounted to a plurality of other portable devices,
the subject data acquisition apparatus including:
an inter-portable-device communication device configured to perform inter-portable-device communication to perform data transmission between the subject data acquisition apparatus and the other data acquisition apparatuses;
a data amount determination section configured to determine whether an amount of the partial data already acquired by the subject data acquisition apparatus is enough to reconstruct the content data;
a complement target search section configured to identify a target data acquisition apparatus from among the other data acquisition apparatuses with which the subject data acquisition apparatus is communicatable in the inter-portable-device communication, when the data amount determination section determines that the amount of the partial data already acquired by the subject data acquisition apparatus is not enough to reconstruct the content data,
the target data acquisition apparatus being one of the other data acquisition apparatuses that has already acquired a part of the partial data, the part (i) having not been acquired by the subject data acquisition apparatus and (ii) being required for the subject data acquisition apparatus to reconstruct the content data; and
a complement section configured to acquire the part of the partial data from the target data acquisition apparatus via the inter-portable-device communication device in the portable-device-to-portable-device communication when the complement target search section successfully identifies the target data acquisition apparatus.
